(19) United States
(12) Patent Application Publication
(10) Pub. No.: US 2006/0193752 A1
(43) Pub. Date: Aug. 31, 2006

(54) Microvolume flowcell apparatus

(76) Inventor: Leanna M. Levine, Redondo Beach, CA (US)

Correspondence Address: Robert Nick, POB 3156, Laguna Hills, CA, 92654, US

(21) Appl. No.: 11/352,849

(22) Filed: Feb. 13, 2006

Related U.S. Application Data
(60) Provisional application No. 60/656,803, filed on Feb. 25, 2005.

(51) Int. Cl. B01L 3/00

(52) U.S. Cl. 422/100

(57) ABSTRACT

A compact microflowcell apparatus having a disposable flowcell unit that can be fabricated with uniform optical characteristics and an associated support fixture adapted to be placed in the sample compartment of a standard fluorimeter or spectrophotometer to accommodate different light path configurations in such instruments.

### CROSS-REFERENCE TO RELATED APPLICATIONS

The present application claims the benefit of priority of Provisional Patent Application Ser. No. 60/656,803 filed Feb. 25, 2005 for Leanna M. Levine, the entire content of which is incorporated herein by reference.

### FIELD OF THE INVENTION

The invention relates to a compact microflowcell apparatus for use in spectrographic and fluorimetric measuring equipment.

### BACKGROUND OF THE INVENTION

A flowcell is generally defined as a device carrying a solution stream that is placed in a path between a light source and light detection system to measure the optical characteristics of the solution stream.

Flowcells are commonly used in devices such as a spectrophotometer, colorimeter, or fluorimeter to measure the light transmissivity, absorbance, and reflectivity characteristics of fluids, solutions, or gases; either in stasis or in dynamic flow.

In practice, the flowcell is fixedly mounted in a suitable holder that is placed in a sample compartment of an analyzer apparatus, such as a fluorimeter, and light is directed to the flowcell carrying the sample fluid or solution being analyzed. The excitation light is transmitted through the sample and/or reflected by the sample in a manner to yield a light output that is representative of a particular characteristic of the fluid or solution.

Prior art flowcells typically comprise transparent bodies adapted to contain a sample volume and are fabricated from quartz or UV transparent plastics. Such flowcells require a relatively large sample volume, on the order of 100 microliters or greater and are fragile and difficult to clean. In addition, the fabrication process generally results in non-uniform optical characteristics producing variations in transmitted or reflected light from unit to unit.

Fluorometers and similar analyzing apparatus often have multiple optical ports configured to direct the excitation and emission light pathways for a sample being analyzed. Such light pathways may be L-shaped, T-shaped, or straight-through paths or a combination of light paths to permit simultaneous measurements of different sample characteristics. In order to accommodate specific optical port configurations, the flowcell holder needs to be designed for the light pathways of the apparatus being used.

The present invention is directed to an improved flowcell and support fixture that has important advantages and benefits over prior art flowcells and holders of the type described above.

The flowcell of the invention has a layered assembly construction to provide a disposable flowcell unit that can be fabricated with uniform optical characteristics. The associated support fixture of the invention is easily adaptable to accommodate different light path configurations in analyzing instruments and can be placed in the sample compartment of a standard fluorimeter, or spectrophotometer.

The flowcell is designed for easy insertion and replacement in the support fixture. In addition, the fluid inlet and outlet ports are located at the top end of the flowcell body. As such, in an installation where it may be difficult to make connections to a prior art type of flowcell, a flowcell of the present invention can be readily accessed so that its connections and mounting are easily reached.

In addition, the flowcell assembly provides for a reduced sample volume and improved optical characteristics.

### BRIEF DESCRIPTION OF THE SEVERAL VIEWS OF THE DRAWING

FIG. 1 is an exploded view of a flowcell of the invention;

FIG. 2 is an assembly view of a flowcell of the invention;

FIG. 3 is an exploded view of a support fixture of the invention;

FIG. 4 is a diagrammatic view of an embodiment of the support fixture of FIG. 3; and

FIG. 5 is a diagrammatic view of an embodiment of a support fixture of the invention.

### DETAILED DESCRIPTION OF THE INVENTION

The apparatus of the invention comprises a disposable microflowcell and support fixture to enable real-time monitoring of chemical and biological samples. The invention is adapted to fit into a conventional cuvette holder found in spectrophotometer or fluorimeter type instruments.

A typical sample to be analyzed by such instruments requires that the cuvette or sample holder contain a minimum sample volume of at least 70 microliters. The microflowcell of the invention, however, can contain chemical or biological samples having sample volumes from about 0.1 to about 30.0 microliters.

The design of the microflowcell allows real-time monitoring of changes in an analyte in the sample stream and permits the same sample volume to be monitored under a variety of sample concentrations. The apparatus of the invention can fit into a standard 1 cm×1 cm cuvette holder.

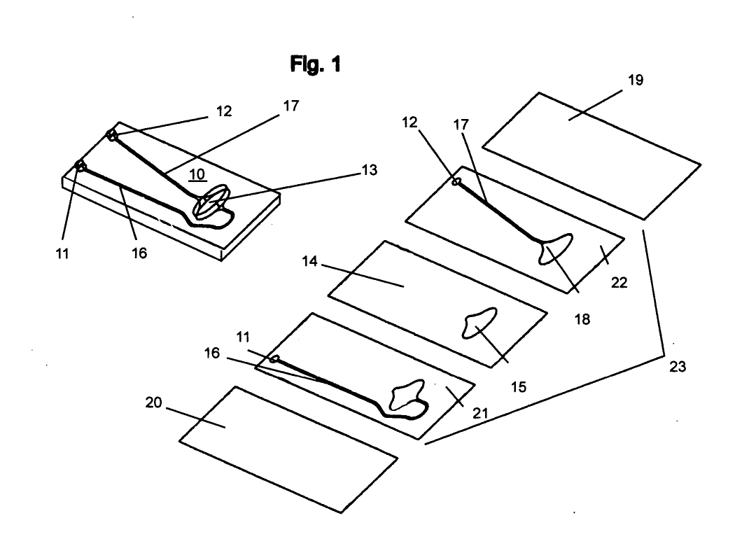

With reference to FIG. 1, a flowcell 10 of the invention comprises a laminated layer assembly having a central layer portion 23, a top film portion 19 and a bottom film portion 20.

The central layer portion of the flowcell comprises a middle segment 14, a top surface segment 22 and a bottom surface segment 21. The middle segment has an aperture 15 defining the contour of a sample receiving well 13. The central layer can be made of black, non-reflective material of various thicknesses to achieve a desired sample well volume.

An outlet port 12 connected to a fluid exit channel 17 is formed on the top surface segment and an inlet port 11 connected to a fluid entrance channel 16 is formed on the bottom surface segment. The channels can be formed using an injection molding or embossing process, or by laminating a thin adhesive layer containing the channels onto the middle segment.

As shown in FIG. 1, the inlet and outlet ports are located in close proximity to each other at a top end of the layer assembly.

The optical window of the flowcell is formed by bonding a thin film (approximately 0.002 inches thick) transparent material 19 on the top surface segment of the central layer and bonding a thin film transparent material 20 on the bottom surface segment of the central layer to cover the aperture 15.

The flowcell assembly is between 0.070 and 0.020 inches thick with a contained volume that varies from 30 microliters to less than 100 nanoliters, depending on the contour of the optical window and the thickness of the central layer.

The optical window is preferably elliptical in shape to optimize the surface area exposed to the excitation light beam of a fluorimeter and the fluorescence light emitted to a detector. The window also has a wide exit channel 18 necking into a thin (approximately 1 mm) channel 17 to allow air bubbles to be trapped away from the light path. In addition, the surface of the flowcell can be treated to reduce air bubble formation by activating the surface using a corona, plasma or flame treatment to create reactive species at the surface that will selectively interact with various gaseous elements that may be present in a reduced atmosphere chamber.

The microflowcell can be used to monitor fluorescence of a sample in the UV and visible light regions by employing selected plastic films to form the optical window. The films can also have surface coatings to optimize optical properties for a particular application. In addition, a porous membrane can be placed in the inlet or outlet pathways to retain materials having relatively large surface areas, such as microbeads, so that reagents can be concentrated on the surface of the material to increase the detection sensitivity. The microbeads can be used in or out of the optical pathways.

Flowcell windows of the invention can also be fabricated from polarized material with one face of the window having vertical polarization and the opposite window face having horizontal polarization. By using a fluorimeter with two light detection pathways set 180 degrees from each other, and the excitation light pathway set at 90° to both, the fluorescence polarization of a sample in the optical window can be monitored in real time. Alternatively, the 180° dual pathway light detection mode can be used to monitor the emission of two different wavelengths of light from the sample. In this application, the surfaces of the optical window are treated or coated to make them opaque to wavelengths detected on opposite window faces.

Another alternative flowcell design can have optical window faces that are UV transparent and non-birefringent. In this application, the flowcell is optimized for depth with the smallest optical window that allows the excitation light source and focusing optics to fill the face of the window with collimated light.

The support fixture of the invention is adapted to hold the microflowcell at a specified angle to the excitation and emission light pathways in analyzer apparatus.

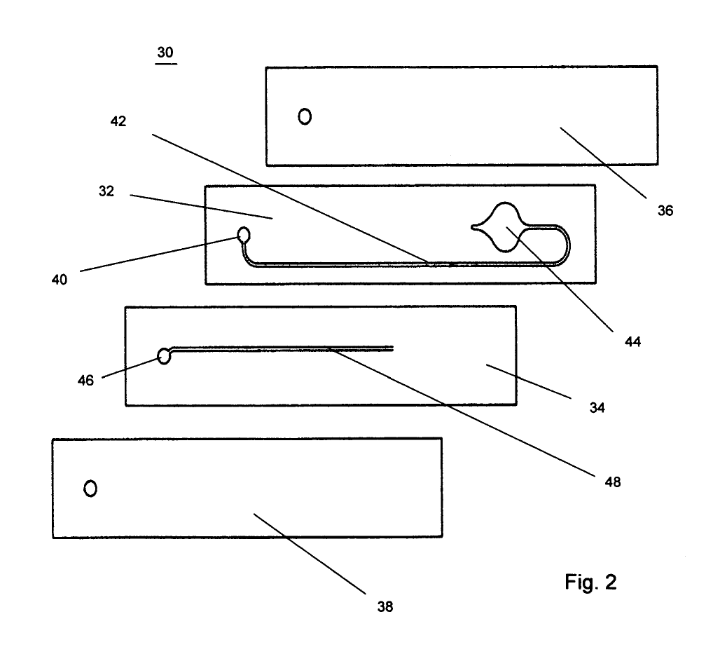

With reference to FIG. 2, another embodiment of a flowcell 30 of the invention is shown, comprising a laminated assembly having a top surface segment 32, a bottom surface segment 34, a top film 36 and a bottom film 38.

An outlet port 46 connected to a fluid exit channel 48 is formed on the bottom surface segment and an inlet port 40 connected to a fluid entrance channel 42 and a sample receiving well through-hole aperture 44 is formed on the top surface segment. The inlet and outlet ports are located in close proximity to each other at a top end of the laminated assembly.

The optical window of the flowcell is formed by bonding a thin (approximately 0.002 inches thick) transparent top layer cover film on the top surface segment and bonding a thin transparent bottom layer cover film on the bottom surface segment to cover the sample receiving well through-hole aperture.

The top and bottom surface segments can be made of black, non-reflective material, such as Delrin, of various thicknesses to achieve a desired sample receiving well volume.

The optical window is preferably elliptical in shape to maximize the surface area exposed to the excitation light beam of a fluorimeter and the fluorescence light emitted to a detector.

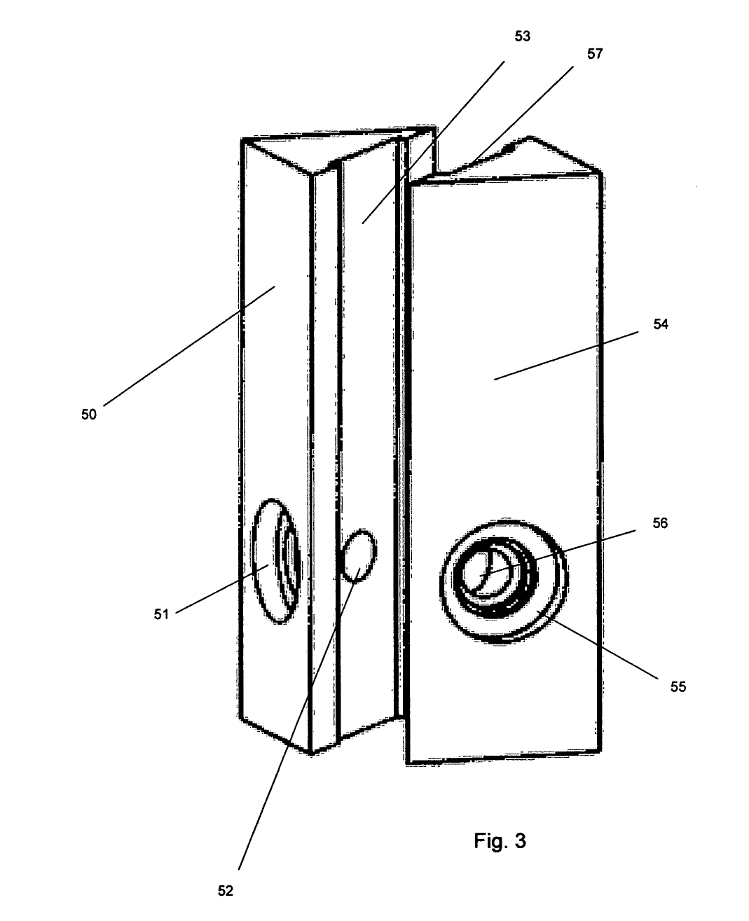

With reference to FIG. 3, an exploded view of a support fixture of the invention is shown comprising a first side portion 50 having a first optical window 51, a through-hole 52 and a corresponding longitudinal slot 53 adapted to receive the flowcell of the invention.

A second side portion 54 of the support fixture has a second optical window 55, a through-hole 56 and a mating longitudinal slot 57 adapted to receive the flowcell.

The fixture is fabricated using a non-reflecting and non-emitting material such as black Delrin, for example, with a flowcell slot along a diagonal of the fixture, adapted to permit the flowcell to slide into place and be positioned in the light pathways of the optical windows.

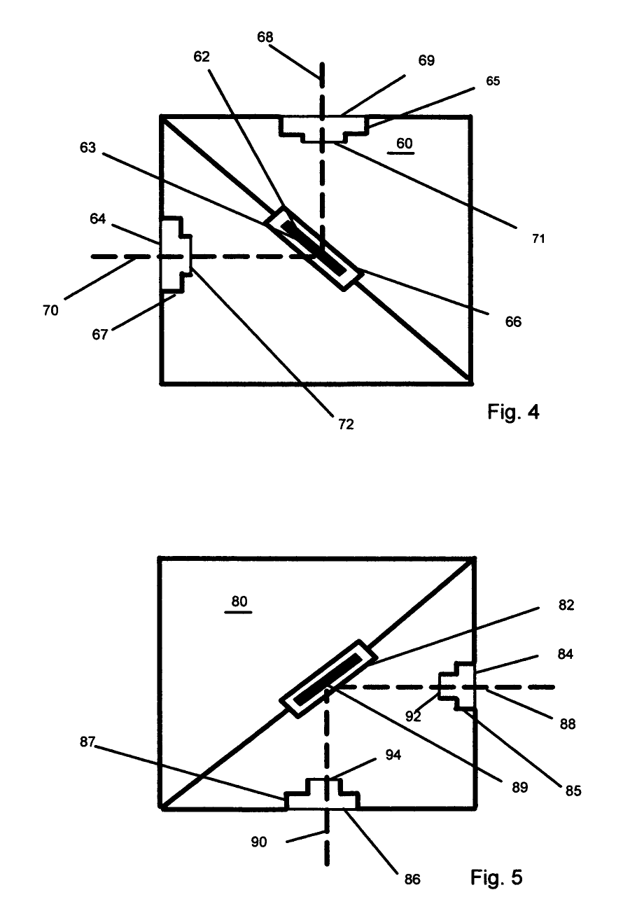

With reference to FIG. 4, one embodiment of the support fixture 60 for use in a standard 90° fluorimeter is shown where a microflowcell 62 is held at a 45° angle between the excitation light 68 and the emission light 70 pathways.

The fixture contains a first optical window 69 and through-hole 71 to allow excitation light to impinge on a first side 62 of the flowcell and a second optical window 64 and through-hole 72 placed at 90° to the excitation light pathway to collect emitted light 70 from a second side 63 of the flowcell. Inserts 65 and 67 are provided in the fixture to hold a focusing lens for the excitation light source and a collimating lens to optimize detection of the emitted light.

With reference to FIG. 5, another embodiment of the fixture is shown where the excitation and emission light pathways are located on the same side of the flowcell.

The fixture contains a first optical window 84 and through-hole 92 to allow excitation light 88 to impinge on the surface of the flowcell 89 and a second optical window 86 and through-hole 94 placed at 90° to the excitation light source to collect emitted light 90 from the same surface of the flowcell. In this embodiment, the fixture is fabricated with a slot 82 along the diagonal that allows the flowcell 89 to slide into place and be held at a 45° angle to the excitation and emission light pathways. Inserts 85 and 87 are provided in the fixture to hold light focusing and collimating lenses.

Although the various features of novelty that characterize the invention have been described in terms of certain preferred embodiments, other embodiments will become apparent to those of ordinary skill in the art, in view of the disclosure herein. Accordingly, the present invention is not limited by the recitation of the preferred embodiments, but is instead intended to be defined solely by reference to the appended claims.

What is claimed is:

1. A microflowcell apparatus to enable real-time monitoring of chemical and biological samples in optical spectrographic and fluorometric equipment; said apparatus comprising a disposable microflowcell and support fixture, said microflowcell operative to carry a sample solution stream, said support fixture adapted to hold said microflowcell at a specified angle to excitation and emission light pathways in said spectrographic and fluorometric equipment,

2. The microflowcell apparatus of claim 1 wherein said disposable microflowcell comprises a sample receiving well having an optical window, said sample receiving well adapted to contain a sample volume from about 0.1 to about 30.0 microliters, said receiving well having a contour adapted to optimize the surface area exposed to excitation and emitted light beams.

3. The disposable microflowcell of claim 2 wherein said receiving well contour is elliptical.

4. The microflowcell apparatus of claim 2 wherein said disposable microflowcell is about 0.02 to about 0.07 inches thick.

5. The disposable microflowcell of claim 4, said microflowcell comprising a laminated layer assembly having a central layer portion, a top portion and a bottom portion, said central layer portion defining a sample receiving well with fluid entrance and exit channels, said top portion comprising a transparent film, said bottom portion comprising a transparent film whereby said films are adapted to cover said central layer portion to provide said sample receiving well having an optical window.

6. The transparent films of claim 5 wherein said films are adapted to provide an optical window suitable to view UV and visible light fluorescence of a sample in said receiving well.

7. The transparent films of claim 5 wherein said films are fabricated from polarized material.

8. The transparent films of claim 5 wherein said films have surface coatings adapted to optimize selected optical properties.

9. The transparent films of claim 5 wherein said films are adapted to provide optical window faces that are UV transparent and non-birefringent.

10. The transparent films of claim 5 wherein said films are adapted to provide optical window faces opaque to selected wavelengths.

11. The support fixture of claim 1 comprising a structure having a longitudinal slot adapted to hold said microflowcell, said structure having a first optical window and through-hole positioned to allow excitation light to impinge on a first surface of said microflowcell and a second optical window and through-hole positioned to collect light emitted from a second surface of said flowcell, said slot positioned to hold said flowcell at a specified angle between excitation light and emission light pathways.

12. The support fixture of claim 11 wherein said specified angle is forty-five degrees.

13. The support fixture of claim 11 wherein said first optical window is adapted to hold a focusing lens and said second optical window is adapted to hold a collimating lens.

14. The support fixture of claim 1 comprising a structure having a longitudinal slot adapted to hold said microflowcell, said structure having a first optical window and through-hole positioned to allow excitation light to impinge on a surface of said microflowcell and a second optical window and through-hole positioned to collect light emitted from said surface of said flowcell, said slot positioned to hold said flowcell at a specified angle between excitation light and emission light pathways.

15. A disposable microflowcell operative to carry a sample solution stream, said microflowcell comprising a sample receiving well having an optical window, said sample receiving well adapted to contain a sample volume from about 0.1 to about 30.0 microliters, said receiving well having a contour adapted to optimize the surface area exposed to excitation and emitted light beams in spectrographic and fluorometric equipment, said microflowcell comprising a laminated layer assembly about 0.02 to about 0.07 inches thick.

16. A disposable microflowcell adapted to carry a sample solution stream, said microflowcell comprising a sample receiving well having an optical window, said sample receiving well having fluid entrance and exit channels, said channels having a porous membrane adapted to retain materials with relatively large surface areas, whereby reagents can be concentrated on the surface of said materials to increase detection sensitivity.
